(19) United States
(12) Patent Application Publication
(10) Pub. No.: US 2025/0356701 A1
(43) Pub. Date: Nov. 20, 2025

(54) DATA COLLECTION DEVICE AND DATA COLLECTION SYSTEM

(71) Applicant: DENSO CORPORATION, Kariya-city (JP)

(72) Inventors: Masato Miyake, Kariya-city (JP); Makiko Tauchi, Kariya-city (JP)

(21) Appl. No.: 19/282,194

(22) Filed: Jul. 28, 2025

Related U.S. Application Data
(63) Continuation of application No. PCT/JP2024/002640, filed on Jan. 29, 2024.

(30) Foreign Application Priority Data
Jan. 31, 2023 (JP) 2023-013170

(51) Int. Cl. G07C 5/00; G07C 5/08; H04L 12/40; H04L 12/66

(52) U.S. Cl. CPC G07C 5/008; G07C 5/085; H04L 12/40; H04L 12/66; H04L 2012/40215; H04L 2012/40273

(57) ABSTRACT

A data collection device collects vehicle data related to a vehicle through different types of communication interfaces. The data collection device includes: a layout converter converting the vehicle data, which is provided by a data providing device and has a signal layout corresponding to one of the communication interfaces, into a common signal layout; a data converter converting the vehicle data, which is converted to have the common signal layout corresponding to the one of the communication interfaces according to a corresponding communication protocol, into data having a common format; a first connector through which the data converter acquires the vehicle data after the vehicle data is converted into the common signal layout by the layout converter; and a communication circuit transmitting the vehicle data, which is converted into the data having the common format by the data converter, to a server.

### CROSS REFERENCE TO RELATED APPLICATIONS

The present application is a continuation application of International Patent Application No. PCT/JP2024/002640 filed on Jan. 29, 2024, which designated the U.S. and claims the benefit of priority from Japanese Patent Application No. 2023-013170 filed on Jan. 31, 2023. The entire disclosures of all of the above applications are incorporated herein by reference.

### TECHNICAL FIELD

The present disclosure relates to a technology that collects vehicle data and transmits the collected vehicle data to a server.

### BACKGROUND

There has been known a technique for collecting vehicle data from an in-vehicle network and transmitting the collected vehicle data to a server.

### SUMMARY

According to an aspect of the present disclosure, a data collection device collects vehicle data related to a vehicle through different types of communication interfaces, and transmits the collected vehicle data to a server. The data collection device includes a layout converter, a data converter, a first connector, and a communication circuit. The layout converter converts the vehicle data, which is provided by a data providing device and has a signal layout corresponding to one of the communication interfaces, into a common signal layout. The data converter converts the vehicle data, which is converted to have the common signal layout corresponding to the one of the communication interfaces according to a corresponding communication protocol, into data having a common format. The first connector is connector through which the data converter acquires the vehicle data after the vehicle data is converted into the common signal layout by the layout converter. The communication circuit transmits the vehicle data, which is converted into the data having the common format by the data converter, to the server. The layout converter includes a common connector, a providing end connector, and a cable. The common connector may be connected to the first connector through which the data converter acquires the vehicle data. The providing end connector may be connected to a second connector of the data providing device. The data providing device may provide the vehicle data that has the signal layout corresponding to the one of the communication interfaces. The cable may connect the common connector with the providing end connector to convert the signal layout of the providing end connector to the common signal layout of the common connector. The vehicle data having the common signal layout may include an interface identifier indicating a type of the one of the communication interfaces. The common connector may include multiple first pins used to specify the interface identifier indicating the type of the one of the communication interfaces and multiple second pins used to transmit the vehicle data.

### BRIEF DESCRIPTION OF DRAWINGS

Features of the present disclosure will become apparent from the following detailed description made with reference to the accompanying drawings. In the drawings:

FIG. 1 is a block diagram showing a configuration of a data management system;

FIG. 2 is a block diagram showing a configuration of a data providing device;

FIG. 3 is a block diagram showing a configuration of a data collection device;

FIG. 4 is a correspondence table for explaining conversion of signal layout by an OBD2 conversion adapter;

FIG. 5 is a correspondence table for explaining conversion of signal layout by an FMS conversion adapter;

FIG. 6 is a correspondence table for explaining conversion of a signal layout by a CAN conversion adapter;

FIG. 7 is a table showing a signal layout of a common connector;

FIG. 8 is a diagram showing a configuration of a common format;

FIG. 9 is a diagram showing conversion of vehicle data of OBD2;

FIG. 10 is a diagram showing conversion of vehicle data of CAN; and

FIG. 11 is a flowchart showing a data collection process.

### DETAILED DESCRIPTION

In a related art, a data collection device collects vehicle data from an in-vehicle network and transmits the collected data to a server located outside of the vehicle. In the vehicle, ECUs are classified into domains according to the functions of vehicle, and an appropriate communication interface is used for each domain in the in-vehicle network. Herein, ECU is an abbreviation for an electronic control unit.

After performing detailed study by the inventors of the present disclosure, it is found that when collecting the vehicle data from a single vehicle equipped with multiple different types of communication interfaces, it is necessary to dispose a device that collects the vehicle data from the different types of communication interfaces equipped to the vehicle.

When collecting the vehicle data from different vehicles through different communication interfaces, it is also found that disposing of different devices are required for collecting the vehicle data from the vehicles having different communication interfaces.

According to an aspect of the present disclosure, a data collection device collects vehicle data related to a vehicle through different types of communication interfaces, and transmits the collected vehicle data to a server. The data collection device includes a layout converter, a data converter, a first connector, and a communication circuit. The layout converter converts the vehicle data, which is provided by a data providing device and has a signal layout corresponding to one of the communication interfaces, into a common signal layout. The data converter converts the vehicle data, which is converted to have the common signal layout corresponding to the one of the communication interfaces according to a corresponding communication protocol, into data having a common format. The first connector is connector through which the data converter acquires the vehicle data after the vehicle data is converted into the common signal layout by the layout converter. The communication circuit transmits the vehicle data, which is converted into the data having the common format by the data converter, to the server. The layout converter includes a common connector, a providing end connector, and a cable. The common connector is connected to the first connector through which the data converter acquires the vehicle data. The providing end connector is connected to a second connector of the data providing device. The data providing device provides the vehicle data that has the signal layout corresponding to the one of the communication interfaces. The cable connects the common connector with the providing end connector to convert the signal layout of the providing end connector to the common signal layout of the common connector. The vehicle data having the common signal layout includes an interface identifier indicating a type of the one of the communication interfaces. The common connector includes multiple first pins used to specify the interface identifier indicating the type of the one of the communication interfaces and multiple second pins used to transmit the vehicle data.

According to another aspect of the present disclosure, a data collection system collects vehicle data related to a vehicle through different types of communication interfaces and transmits the collected vehicle data to a server. The data collection system includes a data providing device and a data collection device. The data providing device includes: a gateway transferring the vehicle data acquired from a network of a vehicle; and a providing device connector providing the vehicle data, which is transferred from the gateway, in a signal layout corresponding to one of the communication interfaces. The data collection device includes: a layout converter converting the signal layout of the vehicle data, which is provided by the data providing device, into a common signal layout; a data converter converting the vehicle data, which is converted to have the common signal layout corresponding to the one of the communication interfaces according to a corresponding communication protocol, into data having a common format; a data collection connector through which the data converter acquires the vehicle data after the vehicle data is converted into the common signal layout by the layout converter; and a communication circuit transmitting the vehicle data, which is converted into the data having the common format by the data converter, to the server. The layout converter includes: a common connector connected to the data collection connector through which the data converter acquires the vehicle data; a providing end connector connected to the providing device connector of the data providing device; and a cable connecting the common connector with the providing end connector to convert the signal layout of the providing end connector to the common signal layout of the common connector. The vehicle data having the common signal layout includes an interface identifier indicating a type of the one of the communication interfaces. The common connector includes multiple first pins used to specify the interface identifier indicating the type of the one of the communication interfaces and multiple second pins used to transmit the vehicle data.

With the above configuration, even when multiple pieces of vehicle data corresponding to different communication interfaces are provided from the data providing device of a single vehicle or from data providing devices of multiple vehicles, the vehicle data can be converted into data having a common format by the common data collection device. Therefore, there is no need to prepare a data collection device corresponding to each communication interface.

In the above-described data collection system, the layout converter connects the connector of the data providing device to the connector through which the data converter of the data collection device acquires the vehicle data, thereby making it possible to easily convert the vehicle data provided via different communication interfaces into the data having the common format.

When the communication interfaces of the multiple pieces of vehicle data provided from the data providing device are different from one another and the signal layouts in the connectors of the data providing device are different from one another, the layout converter that matches the communication interface is prepared. When the communication protocols are different from one another, the data converters that matches respective communication protocols may be prepared.

Since the vehicle data provided via the different communication interfaces are converted into the vehicle data having the common format, the server can easily process the vehicle data converted into the common format.

The following will describe an embodiment of the present disclosure with reference to the drawings.

### 1. Configuration

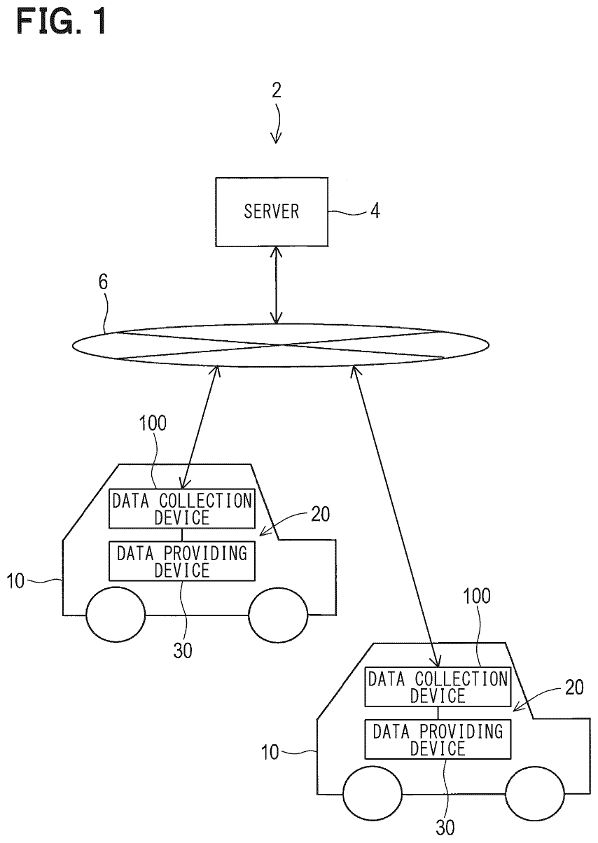

As shown in FIG. 1, a data management system 2 of the present embodiment includes a server 4, a wireless communication network 6, and multiple data collection systems 20.

The server 4 communicates data with the multiple data collection systems 20 via the wireless communication network 6, and manages traveling of each vehicle 10 based on the vehicle data collected from the multiple data collection systems 20.

The data collection system 20 is mounted on each vehicle 10. The data collection system includes a data providing device 30 and a data collection device 100.

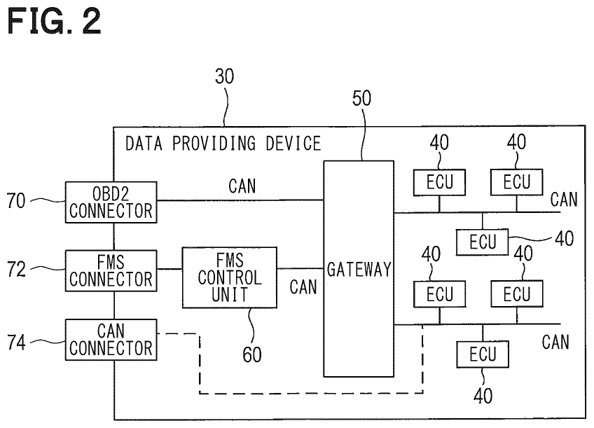

As shown in FIG. 2, the data providing device 30 includes multiple ECUs 40 mounted on the vehicle 10, a gateway 50, an FMS control unit 60, an onboard diagnosis second generation (OBD2) connector 70, an FMS connector 72, and a CAN connector 74. Herein, OBD stands for On Board Diagnostics, FMS stands for Fleet Management System, and CAN stands for Controller Area Network. CAN is a registered trademark.

The ECUs 40 may communicate with one another in each control group using the CAN protocol, and control the traveling of the vehicle 10.

The gateway 50 acquires, as the vehicle data, control values for controlling the vehicle 10 and detection values detected by various sensors equipped to the vehicle 10, from the ECUs 40. The gateway 50 transmits the vehicle data acquired from the ECUs 40 to the OBD2 connector 70 and the FMS connector 72 via respective communication interfaces.

In the present embodiment, the communication interface is at least one of the standards in hardware manner and software manner for performing the communication. The communication protocol indicates at least one of the procedures or data format for performing the communication.

The FMS control unit 60 provides a part of the vehicle data collected from the CAN as data in FMS standard format.

The OBD2 connector 70 and the FMS connector 72 are connectors that are equipped to the vehicle 10 as standard.

Usually, the CAN connector 74 is not equipped to the vehicle 10. The CAN connector 74 is equipped to the vehicle such that the CAN connector 74 is connected on an end of vehicle network of ECUs 40 rather than the gateway 50 and acquires vehicle data, which cannot be acquired by the communication interfaces of the OBD2 connector 70 and the FMS connector 72, when such vehicle data is required. The connectors 70, 72, 74 of the data providing device 30 are also referred to as second connectors or providing device connectors.

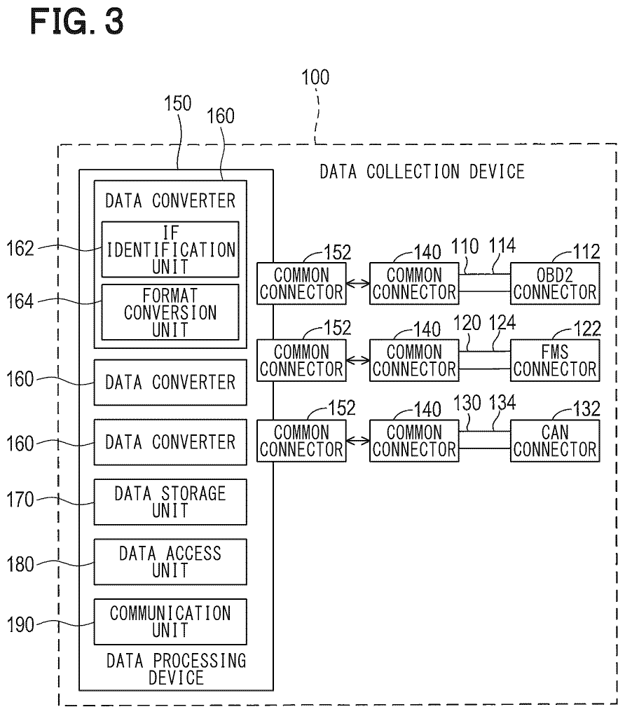

As shown in FIG. 3, the data collection device 100 includes conversion adapters 110, 120, and 130 and a data processing device 150.

The conversion adapter 110 includes an OBD2 connector 112, a cable 114, and a common connector 140. The conversion adapter 120 includes an FMS connector 122, a cable 124, and a common connector 140. The conversion adapter 130 includes a CAN connector 132, a cable 134, and a common connector 140. The common connector 140 in each of the conversion adapters 110, 120, and 130 has the same common signal layout.

The OBD2 connector 112 is connected with the OBD2 connector 70 of the data providing device 30. The FMS connector 122 is connected with the FMS connector 72 of the data providing device 30. The CAN connector 132 is connected with the CAN connector 74 of the data providing device 30.

The common connectors 140 of the conversion adapters 110, 120, 130 are connected to respective common connectors 152 of the data processing device 150. The common connectors 152 of the data processing device 150 are also referred to as first connectors or data collection connector.

The cable 114 connects the OBD2 connector 112 and the common connector 140. The cable 124 connects the FMS connector 122 and the common connector 140. The cable 134 connects the CAN connector 132 and the common connector 140.

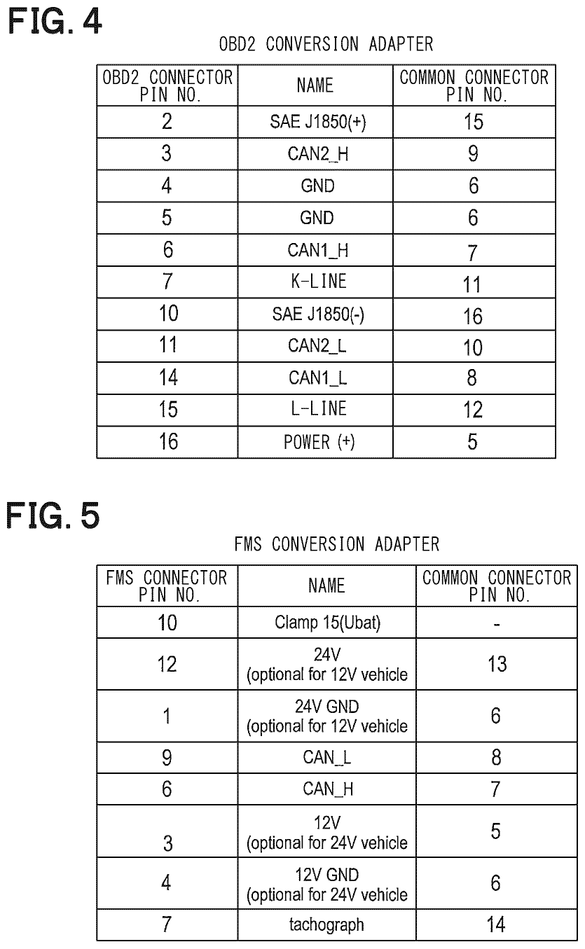

As shown in FIG. 4, the conversion adapter 110 for OBD2 converts, via the cable 114, a signal layout corresponding to the OBD2 interface indicated by the pin numbers of the OBD2 connector 112 into a common signal layout of the common connector 140, via the cable 114.

As shown in FIG. 5, the conversion adapter 120 for FMS converts, via the cable 124, a signal layout corresponding to the FMS interface indicated by the pin numbers of the FMS connector 122 into a common signal layout of the common connector 140.

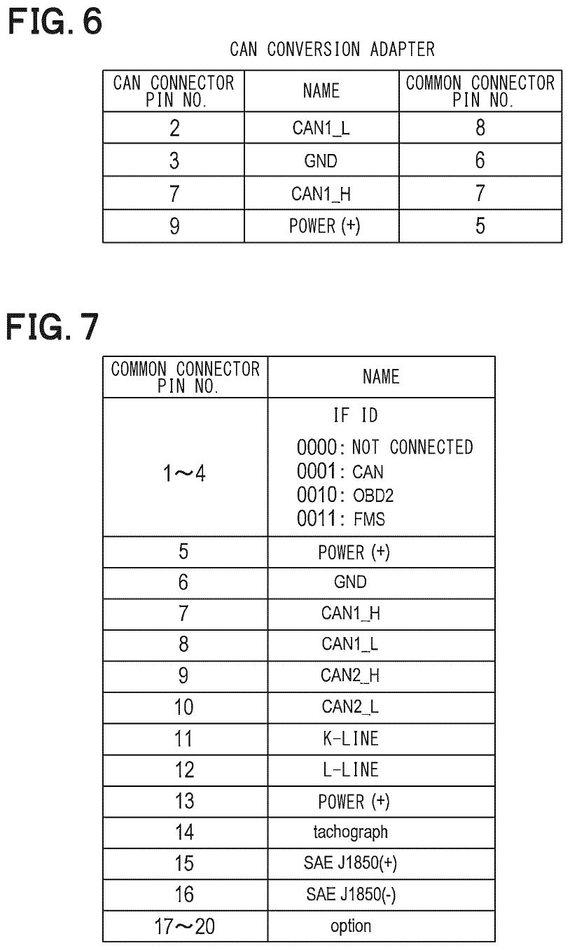

As shown in FIG. 6, the conversion adapter 130 for CAN converts, via the cable 134, a signal layout corresponding to the CAN interface indicated by the pin numbers of the CAN connector 132 into a common signal layout of the common connector 140.

In the OBD2 connector 112, the FMS connector 122, and the CAN connector 132, the power supply (+) or 12V, GND or 12VGND, CAN1_H or CAN_H, and CAN1_L or CAN_L, each is in common and has the same signal. Each of these signals is converted into one signal by each cable 114, 124, 134, and the signal layout is converted to power (+) at pin number 5, GND at pin number 6, CAN1_H at pin number 7, and CAN1_L at pin number 8 of the common connector 140.

The data processing device 150 of the data collection device 100 is supplied with power from the data providing device 30 via a power pin of a common connector 152.

When multiple common connectors 152 are provided for multiple communication interfaces as shown in FIG. 3, wiring is arranged so that the power is supplied from the power pin of only one of the common connectors 152. This is to prevent power from being supplied to the data processing device 150 from multiple power pins of multiple common connectors 152 in a duplicated manner.

Therefore, in order to supply power from the data providing device 30 to the data processing device 150, it is necessary to connect one of the conversion adapters 110, 120, 130 to the common connector 152 arranged at a position where the power is supplied.

As shown in FIG. 7, the signal values of pin numbers 1 to 4 of the common connector 140, which indicate the interface ID, are set to the signal values of the corresponding communication interfaces for each of conversion adapters 110, 120, and 130. Herein, ID stands for identifier. For example, an interface ID signal value of 0b0001 indicates a CAN signal, and a signal value of 0b0010 indicates an OBD2 signal.

The data processing device 150 includes common connectors 152, a data converter 160, a data storage unit 170, a data access unit 180, and a communication circuit 190.

The data processing device 150 is equipped with a microcomputer having, for example, a CPU, a ROM, a RAM, a flash memory, and the like (not shown). The CPU of the data processing device 150 executes a program stored in the ROM or flash memory, thereby carrying out a data collection process, which will be described later.

The common connectors 152 are connected to respective common connectors 140 of the conversion adapters 110, 120, and 130. The signal layouts of the common connectors 152 correspond to the signal layouts of respective common connectors 140 of the conversion adapters 110, 120, and 130.

The data converter 160 includes an interface identification unit 162 and a format conversion unit 164. The data converter 160 is configured independently for each communication interface. The number of conversion units is equal to the number of communication interfaces supported by the data processing device 150. Each data converter 160 obtains a signal from the corresponding one of the common connectors 152.

The interface identification unit 162 identifies the communication interface of the vehicle data acquired from the common connector 152 based on the signal value of the interface ID of the common connector 152.

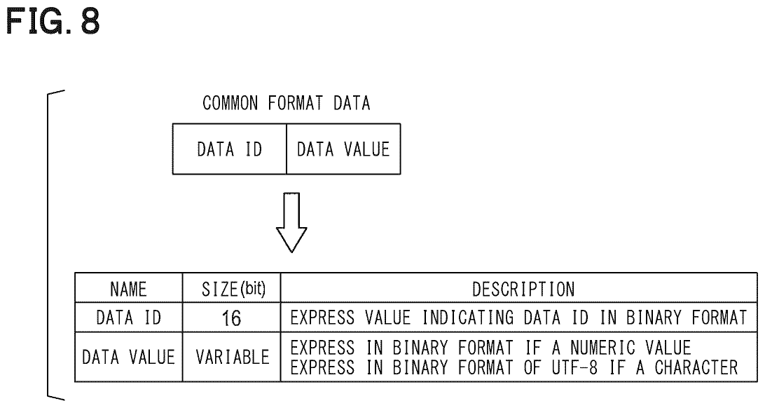

The format conversion unit 164 converts the vehicle data acquired from the common connector 152 into data having the common format as shown in FIG. 8 in accordance with the communication interface identified by the interface identification unit 162.

The data ID of common format indicates what the data represents. For example, the data ID indicates whether the data represents engine speed, vehicle speed, vehicle position, remaining fuel, remaining battery charge, diagnostic code, or the like.

A data value in the common format is, for example, a numeric value expressed in binary. In a case where the data value is a character, it is expressed in binary in UTF-8 format. When the data value is a numerical value, the unit is preset corresponding to the data ID. For example, when the data ID represents a vehicle speed, the unit is set to km/h.

The flowing will describe a process in which the format conversion unit 164 converts the vehicle data acquired from each of the common connectors 152 according to the communication protocol corresponding to the communication interface into data having the common format shown in FIG. 8, using OBD2 and CAN as examples.

### (1) OBD2

The format conversion unit 164 for OBD2 included in the data collection device 100 transmits a message requesting vehicle data to the data providing device 30 via the conversion adapter 110 for OBD2. The request message that requests OBD2 vehicle data is transmitted periodically, or is transmitted when a request is received from an external device of the vehicle 10 via the communication circuit 190.

For example, when collecting vehicle speed data as the vehicle data, the format conversion unit 164 transmits a request message for the vehicle speed data from the common connector 152 via the conversion adapter 110 for OBD2 to the data providing device 30. The signal layout of request message for vehicle speed data is converted by the conversion adapter 110 from the common signal layout of the common connector 152 to the signal layout of the OBD2 connector 112, corresponding to the OBD2 interface.

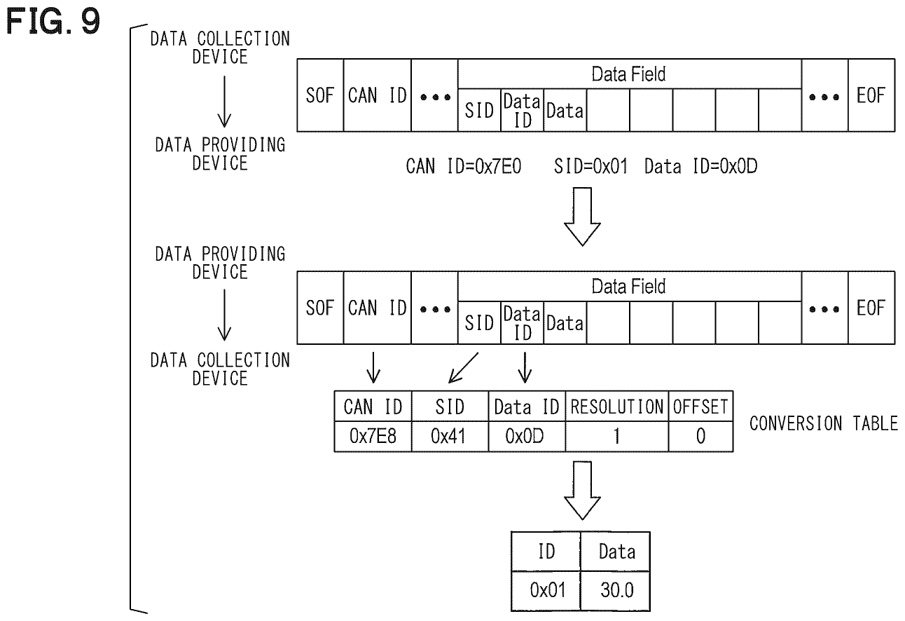

For example, as shown in FIG. 9, a vehicle data request message with CAN ID=0x7E0, SID=0x01, and Data ID=0x0D is transmitted to the data providing device 30 via CAN1_H and CAN1_L of the conversion adapter 110.

Herein, CAN ID=0x7E0 specifies the engine ECU as the ECU of request destination to which vehicle data is requested, SID=0x01 represents request for the current data as a diagnostic service, and Data ID=0x0D represents that the requested data is vehicle speed.

In response to a request for vehicle speed data via OBD2, the data providing device 30 transmits a response message with CAN ID=0x7E8, SID=0x41, and Data ID=0xD to the data collection device 100 via CAN1_H and CAN1_L of the conversion adapter 110. Herein, CAN ID=0x7E8 indicates a response from the engine ECU, SID=0x41 indicates that the response is made to the current data request, and Data ID=0x0D indicates that the response data is vehicle speed.

The signal layout of the response message indicating the vehicle speed data is converted by the conversion adapter 110 from the signal layout of the OBD2 connector 112 corresponding to the OBD2 interface to the common signal layout of the common connector 152.

The format conversion unit 164 acquires the response message of the OBD2 communication protocol that has been converted into the common signal layout by the common connector 152. Then, the format conversion unit 164 refers to the conversion table based on the CAN ID=0x7E8, SID=0x41, and Data ID=0x0D of the response message, and acquires resolution=1 and offset=0.

Then, the format conversion unit 164 extracts the data portion from the response message, multiplies the data portion by the resolution of 1, and adds the offset of 0 to generate the vehicle speed data.

For example, when the generated vehicle speed data is 30 km/h, the format conversion unit 164 converts the generated vehicle speed data into vehicle data having the common format as shown in FIG. 9, that is, vehicle data with the data ID of 0x01 and the data value of 30. Herein, Data ID=0x01 indicates that the vehicle data is vehicle speed.

### (2) CAN

The data collection device 100 acquires a message with CAN ID=0x123 from the data providing device 30 via CAN1_H and CAN1_L of the conversion adapter 130. Herein, CAN ID=0x123 indicates that the message is from an ECU that transmits the vehicle speed.

The signal layout of vehicle speed data is converted by the conversion adapter 130 from the signal layout of the CAN connector 132 corresponding to the CAN interface to the common signal layout of the common connector 152.

The format conversion unit 164 acquires the CAN communication protocol message that has been converted into the common signal layout by the common connector 152. Then, the format conversion unit 164 refers to the conversion table based on the CAN ID=0x123 of the acquired message, thereby acquiring position=1.0, DLC=16 bit, resolution=0.01, and offset=0.

The format conversion unit 164 extracts the data of DLC=16 bit from the position=1.0 in the data portion of the message, multiplies the extracted data by the resolution=0.01, and adds the offset=0 to generate the vehicle speed data.

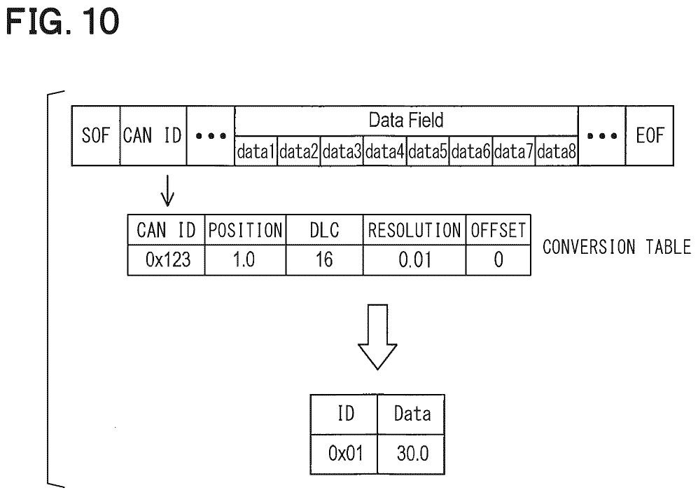

For example, when the generated vehicle speed data is 30 km/h, the format conversion unit 164 converts it the vehicle speed data into vehicle data of the common format as shown in FIG. 10. That is, the vehicle data includes data ID of 0x01 and the data value of 30. Herein, Data ID=0x01 indicates that the vehicle data is vehicle speed.

The vehicle data converted into the common format by the data converter 160 is stored in the data storage unit 170 configured by a memory, such as a RAM or a flash memory. The data stored in the data storage unit 170 is rewritten each time new data is stored, or is rewritten in order from the oldest data in a ring buffer format.

Since the vehicle data stored in the data storage unit 170 has the common format, the data access unit 180 can access the stored data in a common access method, rather than an individual access method corresponding to each communication interface when the data is provided from the data providing device 30.

The communication circuit 190 transmits the vehicle data accessed by the data access unit 180 using the common access method, to the server 4. The communication circuit may be implemented in hardware manner by using a transceiver, or may be implemented in software manner by a processor, and is also referred to as a communication unit.

### 2. Process

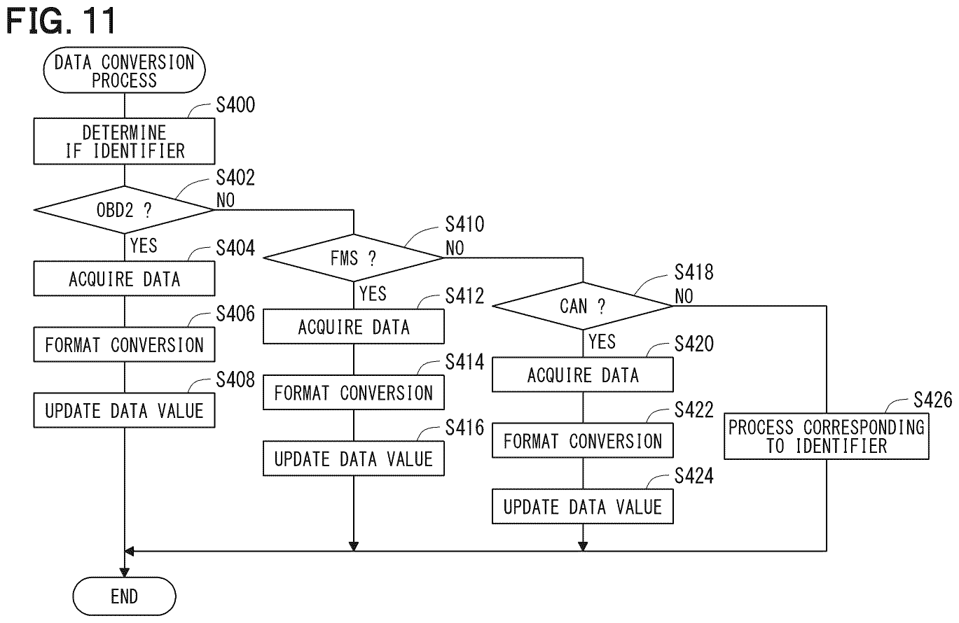

The data collection process executed by the data collection device 100 will be described with reference to the flowchart shown in FIG. 11. The program for executing the flowchart of FIG. 11 is stored in each data converter 160 that is configured independently for each communication interface.

The flowchart shown in FIG. 11 is executed when the data processing device 150 is connected to the data providing device 30 via at least one of the conversion adapters 110, 120, 130 and is supplied with power by the data providing device 30. The flowchart shown in FIG. 11 is executed by the data processing device 150 at predetermined time intervals.

In S400, the interface identification unit 162 identifies the communication interface of the vehicle data acquired from the common connector 152 based on the interface ID indicated by the signal values of pin numbers 1 to 4 of the common connector 152.

When the determination in S402 is NO, that is, when the communication interface is not OBD2, the process proceeds to S410.

When the determination in S402 is YES, that is, when the communication interface is OBD2, the format conversion unit 164 acquires a data signal representing the vehicle data from the common connector 152 based on the communication protocol corresponding to the identified communication interface in S404.

In S406, the format conversion unit 164 converts the vehicle data acquired from the common connector 152 into data having the common format. In S408, the format conversion unit 164 updates the old vehicle data with the current vehicle data and stores the latest data.

When the determination in S410 is NO, that is, when the communication interface is not FMS, the process proceeds to S418.

When the determination in S410 is YES, that is, when the communication interface is FMS, in S412 to S416, the format conversion unit 164 executes the processes similar to the process executed in S404 to S408 described above, substituting FMS for OBD2.

When the determination in S418 is NO, that is, when the communication interface is none of OBD2, FMS, or CAN, the process proceeds to S426.

When the determination in S418 is YES, that is, when the communication interface is CAN, in S420 to S414, the format conversion unit 164 executes the processes similar to the process executed in S404 to S408 described above, substituting CAN for OBD2.

In S426, the format conversion unit 164 executes an appropriate process according to the interface ID indicated by the signal values of the pin numbers 1 to 4 of the common connector 152.

For example, when the interface ID has a value indicating that none of the common connectors 142 of the conversion adapters 110, 120, and 130 is connected to the common connector 152, the process ends without doing anything.

Alternatively, when the interface ID indicated by the signal values of pin numbers 1 to 4 of the common connector 152 is different from a value expected in a normal operation, the format conversion unit 164 notifies the vehicle 10 of the abnormality.

### 3. Technical Effects

The embodiment described above provides the following effects.
(1) Multiple pieces of vehicle data having different communication interfaces provided from the data providing device 30 are converted by the respective conversion adapters 110, 120, 130 and the data converter 160 into data having the common format as described in (a) and (b) below.
(a) The conversion adapters 110, 120, and 130 convert the signal layouts of respective communication interfaces provided by the data providing device 30 into the common signal layout based on the communication interface.
(b) The data converter 160 converts the vehicle data converted into the common signal layout into data having the common format based on the communication protocol corresponding to the communication interface.

As a result, by simply connecting the conversion adapters 110, 120, 130 to the data providing device 30 and the data processing device 150 equipped with the data converter 160, multiple pieces of vehicle data having different communication interfaces can be easily converted into multiple pieces of data having the common format.

When multiple pieces of vehicle data having different communication interfaces are provided from the data providing device 30 of one vehicle 10 or from the data providing devices 30 of multiple vehicles 10, the common data collection device 100 can convert the vehicle data into data having the common format. Therefore, there is no need to individually prepare a data collection device corresponding to a communication interface.

Since the multiple pieces of vehicle data provided via the different communication interfaces are converted into multiple pieces of vehicle data having the common format, the server 4 can easily process the multiple pieces of vehicle data converted into the common format.
(2) When the data providing device 30 converts the signal layout of vehicle data provided according to the communication interface into the common signal layout, the signals common to the communication interfaces are converted into a single signal having the common signal layout. This configuration can minimize signals having the common signal layouts. As a result, the number of pins in the common connectors 140, 152 can be reduced, and the common connectors 140, 152 can be made in a compact size.
(3) The power is supplied from the data providing device 30 to the data processing device 150 of the data collection device 100 via one of the conversion adapters 110, 120, 130. Thus, there is no need to install a power supply in the data collection device 100.
(4) One of the communication interfaces of the conversion adapters 110, 120, and 130 to be connected to the common connector 152 of the data processing device 150 is not defined in advance. Therefore, an interface ID indicating a communication interface is set in each of the signals converted by the respective conversion adapters 110, 120, and 130 into the common signal layout by the common connector 152.

As a result, no matter which of the communication interfaces of the conversion adapters 110, 120, and 130 is connected to the common connector 152, the data converter 160 of the data processing device 150 can identify the communication interface of the connected conversion adapter based on the interface ID.
(5) The OBD2 connector 70 and the FMS connector 72 are typically installed in the vehicle 10. Therefore, when the data providing device 30 uses OBD2 and FMS as the communication interfaces for providing vehicle data, there is no need to additionally install the OBD2 connector 70 and the FMS connector 72 in the vehicle 10.
(6) By using CAN as the communication interface, the data collection device 100 acquires the vehicle data directly from the network of the vehicle 10 rather than from the gateway 50. Thus, it is possible to acquire vehicle data that could not be obtained by OBD2 or FMS.

In the above-described embodiment, the conversion adapters 110, 120, and 130 correspond to layout converter. The OBD2 connector 112, the FMS connector 122, and the CAN connector 132 correspond to providing end connectors.

The processes executed in S402 to S406, S410 to S414, and S418 to S422 correspond to the process executed by the data converter.

### 4. Other Embodiments

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.
(1) In the above embodiment, the data collection device 100 converts multiple pieces of vehicle data having different communication interfaces provided from the data providing device 30 of a single vehicle 10, into multiple pieces of data having the common format. In another example, the data collection device 100 may convert vehicle data of one type of communication interface provided from the data providing device 30 of one vehicle 10 into data having the common format.
(2) In the above embodiment, CAN is used as an example of a network in the vehicle 10. The network provided in a vehicle is not limited to CAN. For example, the network in the vehicle 10 may be Ethernet, a combination of CAN and Ethernet, or another network. Ethernet is a registered trademark.
(3) In the above-described embodiment, OBD2, FMS, and CAN are described as examples of communication interfaces. The communication interfaces are not limited to the described examples. When a communication interface different from OBD2, FMS, or CAN is used and the signal layout of the connector of the data providing device 30 is different, a conversion adapter with a signal layout that matches the communication interface may be prepared. When a communication protocol different from OBD2, FMS, or CAN is used, a data converter 160 corresponding to the different communication interface may be provided additionally.
(4) The data collection system 20 and the data collection device 100, and a method thereof described in the present disclosure may be implemented by a dedicated computer provided by configuring a processor and a memory programmed to execute one or multiple functions provided by execution of a computer program.

Alternatively, the data collection system 20 and the data collection device 100, and the method thereof described in the present disclosure may be implemented by a dedicated computer including a processor implemented by one or more dedicated hardware logic circuits.

Alternatively, the data collection system 20 and the data collection device 100, and the method thereof described in the present disclosure may be implemented by one or more dedicated computers configured by a combination of a processor and a memory programmed to execute one or multiple functions and a processor configured by one or more hardware logic circuits.

The computer program may be stored in a computer-readable non-transitory tangible storage medium as instructions to be executed by the computer. The method for implementing the functions of each unit included in the data collection device 100 does not necessarily need to include software, and all the functions may be implemented by using one or more hardware circuits.
(5) The multiple functions of one component in the above embodiments may be implemented by multiple components, or a function of one component may be implemented by multiple components. Multiple functions of multiple elements may be implemented by one element, one function provided by multiple elements may be implemented by one element. A part of the configuration of the above embodiment may be omitted as appropriate. At least a part of the configuration of the above embodiment may be added to or replaced with the configuration of another above embodiment.
(6) In addition to the above-mentioned data collection device 100, the present disclosure can also be implemented in various modes including a data collection system 20 including the data collection device 100 as a component, a program for causing a computer to function as the data collection device 100, a non-transitory tangible storage medium, such as a semiconductor memory, recording the program, a data collection method, and the like.

What is claimed is:

1. A data collection device collecting vehicle data related to a vehicle through different types of communication interfaces and transmitting the collected vehicle data to a server, the data collection device comprising:
a layout converter converting the vehicle data, which is provided by a data providing device and has a signal layout corresponding to one of the communication interfaces, into a common signal layout;
a data converter converting the vehicle data, which is converted to have the common signal layout corresponding to the one of the communication interfaces according to a corresponding communication protocol, into data having a common format;
a first connector through which the data converter acquires the vehicle data after the vehicle data is converted into the common signal layout by the layout converter; and
a communication circuit transmitting the vehicle data, which is converted into the data having the common format by the data converter, to the server,
wherein
the layout converter includes:
a common connector connected to the first connector through which the data converter acquires the vehicle data;
a providing end connector connected to a second connector of the data providing device, the data providing device providing the vehicle data that has the signal layout corresponding to the one of the communication interfaces; and
a cable connecting the common connector with the providing end connector to convert the signal layout of the providing end connector to the common signal layout of the common connector,
the vehicle data having the common signal layout includes an interface identifier indicating a type of the one of the communication interfaces, and
the common connector includes:
multiple first pins used to specify the interface identifier indicating the type of the one of the communication interfaces; and
multiple second pins used to transmit the vehicle data.

2. The data collection device according to claim 1, wherein
each of the data converter and the communication circuit is supplied with a power from the data providing device through the cable.

3. The data collection device according to claim 2, wherein
a plurality of the layout converters are provided corresponding to the different types of communication interfaces, and
when the plurality of the layout converters connect, via multiple cables, respective second connectors of the data providing device with respective first connectors through which the data converter acquires the vehicle data in accordance with respective different types of communication interfaces, each of the data converter and the communication circuit is supplied with the power from the data providing device through one of the multiple cables.

4. The data collection device according to claim 1, wherein
the data converter converts the vehicle data having the common signal layout into the data having the common format based on the interface identifier.

5. The data collection device according to claim 1, wherein,
when multiple signals from the different types of communication interfaces are same as one another, the multiple signals from the different types of communication interfaces are converted to a single signal having the common signal layout.

6. A data collection system collecting vehicle data related to a vehicle through different types of communication interfaces and transmitting the collected vehicle data to a server, the data collection system comprising:
a data providing device; and
a data collection device,
wherein
the data providing device includes:
a gateway transferring the vehicle data acquired from a network of a vehicle; and
a providing device connector providing the vehicle data, which is transferred from the gateway, in a signal layout corresponding to one of the communication interfaces,
the data collection device includes:
a layout converter converting the signal layout of the vehicle data, which is provided by the data providing device, into a common signal layout;
a data converter converting the vehicle data, which is converted to have the common signal layout corresponding to the one of the communication interfaces according to a corresponding communication protocol, into data having a common format;
a data collection connector through which the data converter acquires the vehicle data after the vehicle data is converted into the common signal layout by the layout converter; and
a communication circuit transmitting the vehicle data, which is converted into the data having the common format by the data converter, to the server,
the layout converter includes:
a common connector connected to the data collection connector through which the data converter acquires the vehicle data;
a providing end connector connected to the providing device connector of the data providing device; and
a cable connecting the common connector with the providing end connector to convert the signal layout of the providing end connector to the common signal layout of the common connector,
the vehicle data having the common signal layout includes an interface identifier indicating a type of the one of the communication interfaces, and
the common connector includes:
multiple first pins used to specify the interface identifier indicating the type of the one of the communication interfaces; and
multiple second pins used to transmit the vehicle data.

7. The data collection system according to claim 6, wherein
the data providing device uses at least one of onboard diagnosis second generation (OBD2) or fleet management system (FMS) as the one of the communication interfaces of the vehicle data when transferring the vehicle data using the gateway.

8. The data collection system according to claim 6, wherein
the data providing device further includes an additional providing device connector that directly provides the vehicle data from the network of the vehicle, instead of providing the vehicle data through the gateway.

9. A data collection method executed by at least one processor equipped to a vehicle, the data collection method collecting vehicle data related to a vehicle through different types of communication interfaces, the data collection method comprising:
converting, by a layout converter, the vehicle data, which is provided by a data providing device and has a signal layout corresponding to one of the communication interfaces, into a common signal layout;
acquiring, through a first connector, the vehicle data after the vehicle data is converted into the common signal layout;
converting, by a data converter, the vehicle data, which is converted to have the common signal layout corresponding to the one of the communication interfaces according to a corresponding communication protocol, into data having a common format; and
transmitting, by a communication circuit, the vehicle data, which is converted into the data having the common format, to a server located outside of the vehicle,
wherein
the layout converter includes:
a common connector connected to the first connector through which the data converter acquires the vehicle data;
a providing end connector connected to a second connector of the data providing device, the data providing device providing the vehicle data that has the signal layout corresponding to the one of the communication interfaces; and
a cable connecting the common connector with the providing end connector to convert the signal layout of the providing end connector to the common signal layout of the common connector,
the vehicle data having the common signal layout includes an interface identifier indicating a type of the one of the communication interfaces, and
the common connector includes:
multiple first pins used to specify the interface identifier indicating the type of the one of the communication interfaces; and
multiple second pins used to transmit the vehicle data.
